(19) United States
(12) Patent Application Publication
(10) Pub. No.: US 2026/0225899 A1
(43) Pub. Date: Aug. 6, 2026

(54) METHOD OF MAKING PASSIVATED SILICON NANOPARTICLES

(71) Applicant: Dow Silicones Corporation, Midland, MI (US)

(72) Inventors: James A. Casey, Midland, MI (US); Charles K. Serrano, Midland, MI (US); David Witker, Midland, MI (US)

(21) Appl. No.: 19/151,356

(22) PCT Filed: Feb. 1, 2024
(86) PCT No.: PCT/US2024/013979

§ 371 Date: Jul. 28, 2025

Related U.S. Application Data
(60) Provisional application No. 63/444,589, filed on Feb. 10, 2023.

(51) Int. Cl. C01B 33/027

(52) U.S. Cl. CPC C01B 33/027; C01P 2004/64

(57) ABSTRACT

A method of passivating silicon nanoparticles, the method comprising: synthesizing silicon nanoparticles, wherein the silicon nanoparticles comprise a free radical, in a plasma reactor; capturing the silicon nanoparticles in a capture fluid composition under vacuum, wherein the capture fluid composition comprises a capture fluid and a free radical-reactive compound, to form a captured silicon nanoparticle composition comprising the capture fluid, the silicon nanoparticles, and the radical reactive compound; and reacting the radical-reactive compound with the free radical of the silicon nanoparticles to produce a passivated composition comprising a passivated silicon nanoparticle and the capture fluid.

### CROSS-REFERENCE TO RELATED APPLICATIONS

None.

### FIELD OF THE INVENTION

The method of the invention is related to the synthesis of silicon nanoparticles in a plasma reactor, capturing the silicon nanoparticle in a capture fluid composition comprising free radical-reactive compound under vacuum, and reacting the free radical-reactive compound with free radicals on the silicon nanoparticles to produce a passivated composition comprising passivated silicon nanoparticles.

### BACKGROUND OF THE INVENTION

The advent of nanotechnology is resulting in a paradigm shift in many technological arts because the properties of many materials change at nanoscale dimensions. For example, decreasing the dimensions of some structures to nanoscales can increase the ratio of surface area to volume, thus causing changes in the electrical, magnetic, reactive, chemical, structural, and thermal properties of the material. Nanomaterials are already being found in commercial applications and will likely be present in a wide variety of technologies including computers, photovoltaics, optoelectronics, medicine/pharmaceuticals, structural materials, military applications, and many others within the next few decades.

Initial research efforts focused on porous silicon, but much interest and effort has now shifted from porous silicon to silicon nanoparticles. An important characteristic of small (less than 10 nanometers (nm) in average size) silicon nanoparticles is that these particles are photoluminescent in visible light when stimulated by lower wavelength sources (UV). This is thought to be caused by a quantum confinement effect that occurs when the diameter of the nanoparticle is smaller than the exciton radius, which results in bandgap bending (i.e., increasing of the gap). Researchers have shown how the bandgap energy (in electron volts) of a nanoparticle changes as a function of the diameter of the nanoparticle.

Although silicon is an indirect bandgap semiconductor in bulk, silicon nanoparticles with diameters less than 10 nm emulate a direct bandgap material, which is made possible by interface trapping of excitons. Direct bandgap materials can be used in optoelectronics applications and so silicon nanoparticles may possibly be the dominant material in future optoelectronic applications. Another interesting property of nanomaterials is the lowering of the melting point following the surface-phonon instability theory. Researchers have shown that the melting point of a nanomaterial formed of nanoparticles changes as a function of the diameter of the nanoparticle.

Industry, universities, and laboratories have devoted substantial effort to the development of manufacturing methods and apparatuses that can be used to produce nanoparticles. Some of those techniques include microreactor plasma, aerosol thermal decomposition of silane, ultrasonication of etched silicon, and laser ablation of silicon. Plasma discharge provides another opportunity to produce nanoparticles at high temperatures from atmospheric plasmas or at approximately room temperature with low pressure plasmas. High temperature plasmas also have been investigated.

Low pressure plasma has been investigated as a method to produce silicon nanoparticles since the 1990's. Nanocrystalline silicon particles have been produced using an ultra high vacuum (UHV) and very high frequency (VHF, ~144 MHz) capacitively coupled plasma. This approach uses a VHF plasma cell attached to a UHV chamber and decomposes silane with the plasma. A carrier gas of hydrogen or argon is pulsed into the plasma cell to push the nanoparticles, formed in the plasma, through an orifice into the UHV reactor where the particles are deposited. The high frequency allows efficient coupling from the rf power to the discharge producing a high ion density and ion energy plasma. Other researchers have employed an inductively coupled plasma (ICP) reactor to make a 13.56 MHz rf plasma that has high ion energy and density.

The ICP reactor does not effectively produce nanoparticles and was replaced by a capacitively coupled discharge. The capacitively coupled system with a ring electrode was able to create a plasma instability that produces a constricted plasma that has an ion density and energy that is much higher than the surrounding glow discharge. This instability rotates around the discharge tube reducing the residence time of the particles in the high energy region. The capacitively coupled system produces smaller nanoparticles when the residence time is shorter because the residence time is approximately the time in which the conditions for nucleation of nanoparticles are favorable. Consequently, reducing the residence time reduces the amount of time available for the particles to nucleate from dissociated precursor(s) molecular fragments and affords a measure of control over the particle size distribution. This method produced nanocrystalline and luminescent silicon particles. However, the radiofrequency power in the capacitively coupled system is not sufficiently coupled to the discharge. Consequently, relatively high input power (~200 W) is needed to deliver even modest power into the plasma (~5 W) because much of the input radiofrequency power is reflected back to the power supply. This greatly reduces the lifetime of the power supply and reduces the cost effectiveness of this technique for production of silicon nanoparticles.

Low pressure high frequency pulsed plasma reactors and direct fluid capture of the nanoparticles formed in the reactor also have been investigated. This method entails using pressure gradients to shoot the nanoparticles at supersonic speeds into a capture fluid to minimize particle size growth.

Potential applications for the nanoparticles may require different absorbance and photoluminescence properties of the nanoparticles. For example, absorbance in the ultraviolet range would be more important than absorbance in a different range in sun protection applications. Also greater photoluminescence may be desired. Although much work has been focused on reactors and methods for producing nanoparticles effectively and efficiently, little work has been done to control the properties of the nanoparticles produced. Therefore, there exists a need for methods of controlling the properties (i.e., absorbance and luminescence) of nanoparticles produced.

### BRIEF SUMMARY OF THE INVENTION

The present invention is directed to a method of passivating silicon nanoparticles, comprising: synthesizing silicon nanoparticles, wherein the silicon nanoparticles comprise a free radical, in a plasma reactor; capturing the silicon nanoparticles in a capture fluid composition under vacuum, wherein the capture fluid composition comprises a capture fluid and a free radical-reactive compound, to form a captured silicon nanoparticle composition comprising the capture fluid, the silicon nanoparticles, and the radical reactive compound; and reacting the radical-reactive compound with the free radical of the silicon nanoparticles to produce a passivated composition comprising a passivated silicon nanoparticle and the capture fluid.

The method of the invention produces silicon nanoparticles with improved photoluminescence.

### BRIEF DESCRIPTION OF THE DRAWINGS

The following detailed description of the present invention can be best understood when read in conjunction with the following drawings, where like structure is indicated with like reference numerals and in which:

FIG. 1 schematically illustrates one exemplary embodiment of a low pressure pulsed plasma reactor which can be used to prepare photoluminescent nanoparticles in accordance with embodiments of the present disclosure.

FIG. 2 displays the normalized photoluminescence emission spectra of nanoparticle compositions passivated by a free radical reactive compound in a capture fluid according to the method of the invention and a comparative example not so passivated. The top plot in FIG. 2 is the as deposited spectra, while the bottom plot is after five days aging at temperature and humidity conditions.

### DETAILED DESCRIPTION OF THE INVENTION

A method of passivating silicon nanoparticles, the method comprising:
synthesizing silicon nanoparticles, wherein the silicon nanoparticles comprise a free radical, in a plasma reactor;
capturing the silicon nanoparticles in a capture fluid composition under vacuum, wherein the capture fluid composition comprises a capture fluid and a free radical-reactive compound, to form a captured silicon nanoparticle composition comprising the capture fluid, the silicon nanoparticles, and the radical reactive compound; and
   reacting the radical-reactive compound with the free radical of the silicon nanoparticles to produce a passivated composition comprising a passivated silicon nanoparticle and the capture fluid.

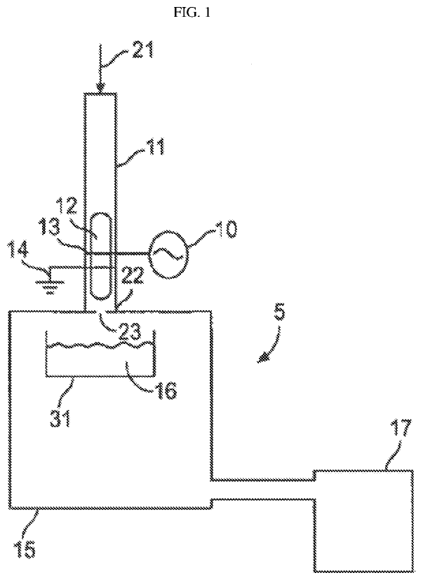

Referring initially to FIG. 1, photoluminescent silicon nanoparticles are prepared by providing at least a first reactant gas mixture to a plasma reactor system 5. The reactant gas mixture typically comprises a first reactive precursor gas and an inert gas. Preferably, the first reactive precursor gas comprises from about 0.1% to about 50% of the total volume of the reactant gas mixture. However, the first reactive precursor gas may comprise other volume percentages such as from about 1% to about 50% of the total volume of the reactant gas mixture.

Preferably, the first reactive precursor gas contains silicon. Generally, the first reactive precursor gas is selected from silanes, disilanes, halogen-substituted silanes, halogen-substituted disilanes, C1-C4 alkyl silanes, C1 to C4 alkyldisilanes, and mixtures thereof. The reactant gas mixture may comprise silane which comprises from about 0.1 to about 2% of the total reactant gas mixture. However, the reactant gas mixture may also comprise other percentages of silane. Alternatively, the first reactive precursor gas may also comprise, but is not limited to, SiCl₄, HSiCl₃, and H₂SiCl₂.

The reactant gas mixture may also optionally comprise an inert gas. Preferably, the inert gas comprises argon. Alternatively, it is also contemplated that the inert gas may comprise xenon, neon, or a mixture of inert gases. When present in the reactant gas mixture, the inert gas may comprise from about 1% to about 99% of the total volume of the reactant gas mixture. However, other volume percentages of inert gas are also contemplated.

The reactant gas mixture can also comprise a second precursor gas which itself can comprise from about 0.1 to about 49.9 volume % of the reactant gas mixture. The second precursor gas comprises BCl₃, B₂H₆, PH₃, GeH₄, or GeCl₄. Alternatively, the second precursor gas may comprise other gases that contain carbon, germanium, boron, phosphorous, or nitrogen. Preferably, the combination of the first reactive precursor gas and the second precursor gas together make up from about 0.1 to about 50% of the total volume of the reactant gas mixture.

The reactant gas mixture can further comprise hydrogen gas. Preferably, hydrogen gas is present in an amount of from about 1% to about 10% of the total volume of the reactant gas mixture. However, it is also contemplated that the reactant gas mixture may comprise other percentages of hydrogen gas.

Referring again to FIG. 1, the plasma reactor system 5 comprises a plasma generating chamber 11 having a reactant gas inlet 21 and an outlet 22 having an aperture or orifice 23 therein. A particle collection chamber 15 is in communication with the plasma generating chamber 11. The particle collection chamber 15 contains a capture fluid composition 16 in a container 31. Container 31 may be adapted to be agitated (by means not shown). For example, container 31 may be positioned on a rotatable support (not shown) or may include a stirring mechanism. Preferably the capture fluid composition is a liquid at the temperatures of operation of the system. The plasma reactor system 5 also includes a vacuum source 17 in communication with the particle collection chamber 15 and plasma generating chamber 11.

The plasma generating chamber 11 comprises an electrode configuration 13 that is attached to a variable frequency rf amplifier 10. The plasma generating chamber 11 also comprises a second electrode configuration 14. The second electrode configuration 14 is either ground, DC biased, or operated in a push-pull manner relative to the electrode 13. The electrodes 13, 14 are used to couple the very high frequency (VHF) power to the reactant gas mixture to ignite and sustain a glow discharge of plasma within the area identified as 12. The first reactive precursor gas (or gases) is then dissociated in the plasma to provide charge silicon atoms which nucleate to form silicon nanoparticles having an average silicon core diameter of less than about 10 nm, and preferably from between about 2.2 to about 4.7 nm. However, other discharge tube configurations are contemplated, and may be used in carrying out the method disclosed herein.

The silicon nanoparticles comprise free radicals. One will appreciate that each silicon nanoparticle produced may or may not contain one or more free radicals, but some portion of the silicon nanoparticles produced in the process comprise free radicals.

The silicon nanoparticles are collected in particle collection chamber 15 in the capture fluid composition. To control the diameter of the nanoparticles which are formed, the distance between the aperture 23 in the outlet 22 of plasma generating chamber 11 and the surface of the capture fluid composition ranges between about 5 to about 50 aperture diameters. We have found that positioning the surface of the capture fluid composition too close to the outlet of the plasma generating chamber may result in undesirable interactions of plasma with the capture fluid composition. Conversely, positioning the surface of the capture fluid composition too far from the aperture reduces particle collection efficiency. As collection distance is a function of the aperture diameter of the outlet and the pressure drop between the plasma generating chamber and the collection chamber, we have found that based on the operating condition described herein, an acceptable collection distance is from about 1 to about 20 cm, and preferably from about 5 to about 10 cm. Stated another way, an acceptable collection distance is from about 5 to about 50 aperture diameters.

The plasma generating chamber 11 also comprises a power supply. The power is supplied via a variable frequency radio frequency power amplifier 10 that is triggered by an arbitrary function generator to establish high frequency pulsed plasma in area 12. Preferably, the radiofrequency power is capacitively coupled into the plasma using a ring electrode, parallel plates, or an anode/cathode setup in the gas. Alternatively, the radiofrequency power may be inductively coupled mode into the plasma using an rf coil setup around the discharge tube.

The plasma generating chamber 11 may also comprise a dielectric discharge tube. Preferably, a reactant gas mixture enters the dielectric discharge tube where the plasma is generated. Nanoparticles which form from the reactant gas mixture start to nucleate as the first reactive precursor gas molecules are dissociated in the plasma.

The vacuum source 17 typically comprises a vacuum pump. The vacuum source 17 may comprise a mechanical, turbo molecular, or cryogenic pump. However, other vacuum sources are also contemplated.

The electrodes 13, 14 for a plasma source inside the plasma generating chamber 11 typically comprise a flow-through showerhead design in which a VHF radio frequency biased up-stream porous electrode plate 13 is separated from a downstream porous electrode plate 14, with the pores of the plates aligned with one another. The pores may be circular, rectangular, or any other desirable shape. Alternatively, the plasma generating chamber 11 may enclose an electrode 13 that is coupled to the VHF radio frequency power source and has a pointed tip that has a variable distance between the tip and a grounded ring inside the chamber 11.

The VHF radio frequency power source typically operates in a frequency range of about 30 to about 500 MHz. The pointed tip 13 can be positioned at a variable distance from a VHF radio frequency powered ring 14 operated in a push-pull mode (180° out of phase). The electrodes 13, 14 can include an inductive coil coupled to the VHF radio frequency power source so that radio frequency power is delivered to the reactant gas mixture by an electric field formed by the inductive coil. Portions of the plasma generating chamber 11 can be evacuated to a vacuum level ranging between 0.133 milliPascal to 67 MegaPascal (1×10⁻⁷ to 500 Torr). However, other electrode coupling configurations are also contemplated for use with the method disclosed herein.

The plasma in area 12 can be initiated with a high frequency plasma via an rf power amplifier such as, for example, an AR Worldwide Model KAA2040, or an Electronics and Innovation Model 3200L, or an EM Power RF Systems, Inc. Model BBS2E3KUT. The amplifier can be driven (or pulsed) by an arbitrary function generator (e.g., a Tektronix AFG3252 function generator) that is capable of producing up to 200 watts of power from 0.15 to 150 MHz. The arbitrary function may be able to drive the power amplifier with pulse trains, amplitude modulation, frequency modulation, or different waveforms. The power coupling between the amplifier and the reactant gas mixture typically increases as the frequency of the rf power increases. The ability to drive the power at a higher frequency may allow more efficient coupling between the power supply and discharge. The increased coupling may be manifested as a decrease in the voltage standing wave ratio (VSWR).

$$VSWR = \frac{1 + p}{1 - p} , \qquad ( 1 )$$

where p is the reflection coefficient,

$$p = \frac{Zp - Z c}{Zc + Zp} \qquad ( 2 )$$

with Zp and Zc representing the impedance of the plasma and coil respectively. At frequencies below 30 MHz, only 2-15% of the power is delivered to the discharge. This has the effect of producing high reflected power in the rf circuit that leads to increased heating and limited lifetime of the power supply. In contrast, higher frequencies allow more power to be delivered to the discharge, thereby reducing the amount of reflected power in the rf circuit.

The power and frequency of the plasma system is typically preselected to create an optimal operating space for the formation of photoluminescent silicon nanoparticles. Preferably, tuning both the power and frequency creates an appropriate ion and electron energy distribution in the discharge to help dissociate the molecules of silicon-containing reactive precursor gas and nucleate the nanoparticles. Appropriate control of both the power and frequency prevents the silicon nanoparticles from growing too large.

Referring again to FIG. 1, one exemplary embodiment of a low pressure high frequency pulsed plasma reactor 5 is schematically illustrated. In the illustrated embodiment, a reactant gas mixture is introduced to a plasma generating chamber 11. The plasma reactor 5 may be operated in the frequency range of from 30 MHz to 150 MHz, at pressures from 13 Pascal to 1.33 MegaPascal (100 mTorr to 10 Torr) in the plasma generating chamber 11, and with a power of from about 1 W to about 200 W. However, other powers, pressures, and frequencies of the plasma reactor 5 are also contemplated.

The pulsed plasma system illustrated in FIG. 1 may be used to produce photoluminescent silicon nanoparticles. Pulsing the plasma enables an operator to directly manage the residence time for particle nucleation, and thereby control the particle size distribution and agglomeration kinetics in the plasma. The pulsing function of the system allows for controlled tuning of the particle residence time in the plasma, which affects the size of the nanoparticles. By decreasing the “on” time of the plasma, the nucleating particles have less time to agglomerate, and therefore the size of the nanoparticles may be reduced on average (i.e., the nanoparticle distribution may be shifted to smaller diameter particle sizes).

Advantageously, the operation of the plasma reactor system 5 at higher frequency ranges, and pulsing the plasma provides the same conditions as in conventional constricted/filament discharge techniques that use a plasma instability to produce the high ion energies/densities, but with the additional advantage that users can control operating conditions to select and produce nanoparticles having sizes which result in photoluminescent properties.

For a pulse injection, the synthesis of the nanoparticles can be done with a pulsed energy source, such as a pulsed very high frequency rf plasma, a high frequency rf plasma, or a pulsed laser for pyrolysis. Preferably, the VHF radiofrequency is pulsed at a frequency ranging from about 1 to about 50 kHz. However, it is also contemplated that the VHF radiofrequency may be pulsed at other frequencies.

Another method to transfer the nanoparticles to the capture fluid composition is to pulse the input of the reactant gas mixture while the plasma is ignited. For example, one could ignite the plasma in which a first reactive precursor gas is present is ignited to synthesize the Si nanoparticles, with at least one other gas present to sustain the discharge, such as an inert gas. The nanoparticle synthesis is stopped when the flow of first reactive precursor gas is stopped with a mass flow controller. The synthesis of the nanoparticles continues when the flow of the first reactive precursor gas is started again. This produces a pulsed stream of nanoparticles. This technique can be used to increase the concentration of nanoparticles in the capture fluid composition if the flux of nanoparticles impinging on the capture fluid composition is greater than the absorption rate of the nanoparticles into the capture fluid composition.

Generally, the nanoparticles can be synthesized at increased plasma residence time relative to the precursor gas molecular residence time through a VHF radio frequency low pressure plasma discharge. Alternatively, crystalline nanoparticles can be synthesized at lower plasma residence times at the same operating conditions of discharge drive frequency, drive amplitude, discharge tube pressure, chamber pressure, plasma power density, gas molecule residence time through the plasma, and collection distance from plasma source electrodes. The mean particle diameter of nanoparticles can be controlled by controlling the plasma residence time and a high ion energy/density region of a VHF radio frequency low pressure glow discharge can be controlled relative to at least one precursor gas molecular residence time through the discharge.

The size distribution of the nanoparticles can also be controlled by controlling the plasma residence time, a high ion energy/density region of the VHF radio frequency low pressure glow discharge relative to said at least one precursor gas molecular residence time through the discharge. Typically, the lower the plasma residence time of a VHF radio frequency low pressure glow discharge relative to the gas molecular residence time, the smaller the mean nanoparticle diameter at constant operating conditions. The operating conditions may be defined by the discharge drive frequency, drive amplitude, discharge tube pressure, chamber pressure, plasma power density, precursor mass flow rates, and collection distance from plasma source electrodes. However, other operating conditions are also contemplated. For example, as the plasma residence time of a VHF radio frequency low pressure glow discharge relative to the gas molecular residence time increases, the mean nanoparticle diameter follows an exponential growth model of y=y₀−exp(−tᵣ/C), where y is the mean nanoparticle diameter, y₀ is the offset, tᵣ is the plasma residence time, and C is a constant. The particle size distribution may also increase as the plasma residence time increases under otherwise constant operating conditions.

The mean particle diameter of the nucleated nanoparticles (as well as the nanoparticle size distribution) can be controlled by controlling a mass flow rate of at least one precursor gas in a VHF radio frequency low pressure glow discharge. For example, as the mass flow rate of precursor gas (or gases) increases in the VHF radio frequency low pressure plasma discharge, the synthesized mean nanoparticle diameter may decrease following an exponential decay model of the form y=yₒ+exp(−MFR/C′), where y is the mean nanoparticle diameter, yₒ is the offset, MFR is the precursor mass flow rate, and C′ is a constant, for constant operating conditions. Typical operating conditions may include discharge drive frequency, drive amplitude, discharge tube pressure, chamber pressure, plasma power density, gas molecule residence time through the plasma, and collection distance from plasma source electrodes. The synthesized mean core nanoparticle particle size distribution may also decrease as an exponential decay model of the form y=yₒ+exp(−MFR/K), where y is the mean nanoparticle diameter, yₒ is the offset, MFR is the precursor mass flow rate, and K is a constant, for constant operating conditions.

As described previously, the nucleated nanoparticles formed in the plasma generating chamber 11 are transferred to a particle collection chamber 15 containing the capture fluid composition 16. Preferably, the charged nanoparticles may be evacuated from chamber 11 to the particle collection chamber 15 by cycling the plasma to a low ion energy state, or by turning the plasma off. Upon transfer to the particle collection chamber 15, the nucleated nanoparticles are absorbed into the capture fluid composition.

The nucleated nanoparticles can be transferred from the plasma generating chamber 11 to particle collection chamber 15 containing the capture fluid composition via an aperture or orifice 23 which creates a pressure differential. It is contemplated that the pressure differential between the plasma generating chamber 11 and the particle collection chamber 15 can be controlled through a variety of means. In one configuration, the discharge tube inside diameter of the plasma generating chamber 11 is much less than the inside diameter of the particle collection chamber 15, thus creating a pressure drop. In another configuration, a grounded physical aperture or orifice may be placed between the discharge tube and the collection chamber 15 that forces the plasma to reside partially inside the orifice, based on the Debye length of the plasma and the size of the chamber 15. Another configuration comprises using a varying electrostatic orifice in which a positive concentric charge is developed that forces the negatively charged plasma through the aperture 23.

The capture fluid composition comprises a capture fluid and a free radical reactive compound.

The capture fluid of the capture fluid composition is typically selected so that the capture fluid composition can be used for silicon nanoparticle capture and, desirably, a material handling and storage medium. The capture fluid can be selected from any fluid that will allow nanoparticles to disperse into the capture fluid composition as they are collected and inhibit particle-particle interactions, thus forming a dispersion or suspension of nanoparticles in the capture fluid composition. As such, the nanoparticles and capture fluid are miscible. The capture fluid can be a mixture of miscible fluids, at least one of which may be the free-radical reactive compound.

The vapor pressure of the capture fluid is desirably lower than the operating pressure in the plasma reactor. Preferably, the operating pressure in the reactor and collection chamber 15 range from 0.133 Pascal to 0.667 Pascal (1 to 5 millitorr). Other operating pressures are also contemplated.

The capture fluid desirably comprises, and can consists of, a silicone fluid, a hydrocarbon fluid, and/or a halocarbon fluid. Thee silicone fluid, hydrocarbon fluid, and/or halocarbon fluid can contain substituted groups. Substituted groups for the capture fluid include, but are not limited to, unsaturated hydrocarbyl having from 2 to 12 carbon atoms, borate, boronic acid, amide, azide, azo, amino, carbodiimide, imine, isocyanate, nitrile, nitro, alcohol, aldehyde, carboxylic acid, epoxy, ester, ether, hydroxyl, keto, peroxy, phosphate, phosphine, phosphine oxide, phosphinite, phosphite, phosphonate, phosphonite, disulfide, thioether, thiol, or halo, or silanol, alternatively hydroxyl, amine or vinyl. The substituted groups will typically modify the absorbance and photoluminescence of the silicon nanoparticles. The capture fluid may be a single material or a mixture of two or more capture fluids. When the capture fluid is a mixture, none to all of the capture fluids may be substituted.

Examples of silicone fluids comprised by the capture fluid include, but are not limited to, polydimethylsiloxane, mixed phenylmethyl-dimethyl cyclosiloxane, tetramethyltetraphenyltrisiloxane, and penta phenyltrimethyltrisiloxane are all suitable for use as capture fluids.

Examples of hydrocarbon fluids that may be comprised by the capture fluid include, but are not limited to, branched and linear hydrocarbons having from 20 to 40 carbon atoms, alternatively refined petroleum oil distillates solvent-refined paraffinics.

The capture fluid has a viscosity sufficient to capture the silicon nanoparticles and to be agitated to keep the particle from agglomerated, alternatively a viscosity from 1 to 500, alternatively from 10 to 100 millipascals*seconds (centipoise). One skilled in the art would know how to measure the viscosity of a fluid. The viscosity is measured using at 25° C. using a Brookfield LV Series Viscometer, spindle 12, at 12 rpm.

One skilled in the art would know how to make and/or acquire the capture fluids of the invention. Many of these fluids are available commercially. Capture fluids generally can be reused multiple times in a process of the present invention. To reuse the capture fluid, it is common to isolate the silicon nanoparticles from the capture fluid (for example, by filtration or centrifugation followed by decantation) and then use the recovered capture fluid again to capture additional silicon nanoparticles.

The silicon nanoparticles synthesized according to the method of the invention comprise free radicals.

The free radical reactive compound is any compound that will react with the radicals of the silicon nanoparticles and/or non-radical reactive sites on the silicon nanoparticles. The reaction of the free radicals and/or other reactive sites with the free radical reactive compound produce nanoparticles with greater photoluminescence than if no free radical reactive compound is included. Examples of non-radical reactive sites include hydride groups.

The free radical reactive compound can be an organic compound, alternatively a hydrocarbon having from 1 to 25 carbon atoms that will react with the free radicals of the silicon nanoparticles, alternatively an organic compound having from 1 to 25 carbon atoms and unsaturation, alternatively an organic compound having from 1 to 25 carbon atoms and an alkenyl group or alkynyl group, alternatively an alkenyl group, alternatively an organic compound having from 1 to 25 carbon atoms and an ester functional group. The free radical reactive compound can be according to the formula (I)

(I) R¹C(═O)R², where R¹ is hydrocarbyl having from 1 to 20 carbon atoms, alternatively 1 to 12 carbon atoms, R² is hydrocarbyl having from 1 to 6 carbon atoms, where one of R¹ and R² has a carbon-carbon double bond or triple bond, alternatively R² has a carbon-carbon double or triple bond. The free radical reactive compound can be a C₁₋₂₅ alkenylalkanoate, alternatively allyl alkanoate, alternatively allyl (C₆₋₁₂)alkanoate, alternatively allyl decanoate.

The free radical reactive compound and the capture fluid may be the same material, in which case the capture fluid comprises a free radical reactive group. The free radical reactive group comprised by the capture fluid is an organic group, alternatively a hydrocarbyl group having from 1 to 25 carbon atoms that will react with the free radicals of the silicon nanoparticles, alternatively an organic group having from 1 to 25 carbon atoms and unsaturation, alternatively an organic group having from 1 to 25 carbon atoms and an alkenyl or alkynyl functionality, alternatively an alkenyl functionality, alternatively an organic group having from 1 to 25 carbon atoms and an ester functional group. The free radical reactive group can be according to the formula (II) (I) R³C(═O)R⁴, where R³ is hydrocarbylene linking group having from 1 to 20 carbon atoms, alternatively 1 to 12 carbon atoms, R² is hydrocarbyl having from 1 to 6 carbon atoms, where one of R³ and R⁴ has a carbon-carbon double bond or triple bond, alternatively R⁴ has a carbon-carbon double or triple bond.

The silicon nanoparticles can be exposed to the free radical reactive compound after the silicon nanoparticles are synthesized and before the nanoparticles are exposed to oxygen or any other passivating agent or compound such as nitrogen or hydrogen, or before surface oxidation occurs. The free radical reactive compound can be present as the silicon nanoparticles are captured in the capture fluid composition, alternatively, the free radical reactive compound is added to the capture fluid and the silicon nanoparticles after the silicon nanoparticles are captured in the capture fluid to form the capture fluid composition.

The silicon nanoparticles are reacted with the free radical reactive compound in the capture fluid composition to form a passivated composition comprising a passivated silicon nanoparticle and the capture fluid.

The passivated silicon nanoparticle is a silicon nanoparticle that has reacted with the free radical reactive compound. The reaction may involve the reaction of a free radical or a free radical and a non-radical reactive site of the silicon nanoparticle with the free radical reactive compound. The reaction of the free radical reactive compound and the radical or non-radical reactive site of the silicon nanoparticle prevents or removes defects from the silicon nanoparticles.

The passivated composition also comprises the capture fluid and the reaction byproduct of the free radical reactive compound with the silicon nanoparticle free radical or other reactive group.

The capture fluid composition is desirably agitated during the direct capture of the nanoparticles. Contemplated forms of agitation that are acceptable include stirring, rotation, inversion, and other suitable means. If higher absorption rates of the nanoparticles into the capture fluid are desired, more intense forms of agitation are contemplated. For example, one method of such intense agitation contemplated for use includes ultrasonication.

Upon the dissociation of the first reactive precursor gas in the plasma generation chamber 11, silicon nanoparticles form and are entrained in the gas phase. The distance between the nanoparticle synthesis location and the surface of capture fluid composition must be short enough so that no unwanted functionalization occurs while the nanoparticles are entrained. If particles interact within the gas phase, agglomerations of numerous individual small particles will form and be captured in the capture fluid composition. If too much interaction takes place within the gas phase, the particles may sinter together and form particles larger than 10 nm in diameter. The collection distance is defined as the distance from the outlet of the plasma generating chamber to the surface of the capture fluid composition. The collection distance typically ranges from about 5 to about 50 aperture diameters.

Stated another way, the collection distance ranges from about 1 to about 20 cm. The collection distance may more usually range from between about 6 to about 12 cm, and preferably from about 5 to about 10 cm. However, other collection distances are also contemplated.

The nanoparticles may comprise silicon alloys. Silicon alloys that may be formed include, but are not limited to, silicon carbide, silicon germanium, silicon boron, silicon phosphorous, and silicon nitride. The silicon alloys may be formed by mixing at least one first precursor gas with the second precursor gas or using a precursor gas that contains the different elements. However, other methods of forming alloyed nanoparticles are also contemplated.

The silicon nanoparticles can undergo an additional doping step. Preferably, the silicon nanoparticles undergo gas phase doping in the plasma, where a second precursor gas is dissociated and is incorporated in the silicon nanoparticles as they are nucleated. Alternatively, the silicon nanoparticles may undergo doping in the gas phase downstream of the production of the nanoparticles, but before the silicon nanoparticles are captured in the liquid. Furthermore, doped silicon nanoparticles may also be produced in the capture fluid composition where the dopant is preloaded into the capture fluid composition and interacts with the nanoparticles after they are captured. Doped nanoparticles can be formed by contact with organosilicon gases or liquids, including, but not limited to trimethylsilane, disilane, and trisilane. Gas phase dopants may include, but are not limited to, BCl₃, B₂H₆, PH₃, GeH₄, or GeCl₄.

The inclusion of the free radical reactive compound in the capture fluid composition and direct liquid capture of the nanoparticles in the capture fluid composition provides unique properties to the composition. Silicon nanoparticles that are directly captured in a capture fluid composition show visible photoluminescence when removed from the system and excited by exposure to UV light. The photoluminescence of the silicon nanoparticles increases with the use of the method of the invention, where the silicon nanoparticles free radicals are reacted with a free radical reactive compound in the capture fluid, compared to nanoparticle capture in capture fluids not containing the free radical reactive compound. Depending also on the average diameter of the nanoparticles, they may photoluminesce in any of the wavelengths in the visible spectrum and may visually appear to be red, orange, green, blue, violet, or any other color in the visible spectrum. The inclusion of different groups and/or compounds in the capture fluid also affects quantum luminescent efficiency and absorbance. The photoluminescent silicon nanoparticles produced according to the invention which are directly captured in the capture fluid composition typically have a photoluminescent intensity of at least 1×10⁶ counts per second at an excitation wavelength of about 365 nm. The photoluminescent silicon nanoparticles which are directly captured typically have a quantum efficiency of at least 4% at an excitation wavelength of about 395 nm as measured on an Ocean Optics spectrophotometer with an integrating sphere with an absorption of >10% of the incident photons.

Furthermore, both the photoluminescent intensity and luminescent quantum efficiency of the direct capture composition continue to increase over time when the nanoparticle containing capture fluid composition is exposed to air. The maximum emission wavelength of the nanoparticles directly captured in a fluid tend to shift to shorter wavelengths over time when exposed to oxygen.

The photoluminescent intensity can be modified, increased for example, by capturing the silicon nanoparticles in the capture fluid composition according to the method of the invention. The photoluminescent intensity can be modified, desirably increased, at least 2, alternatively at least 5, alternatively at least 15 normalized units where “normalized units” are photoluminescent emission intensity values measured on the same day and normalized to the maximum photoluminescent emission intensity of a control sample (that is, using the same method except without the free radical reactive compound). The photoluminescent intensity modification can be evident even when measured after aging at passivating conditions. Passivating conditions are a temperature of 30 degrees Celsius (° C.) or higher, or 50° C. or higher, or even 60° C. or higher while at the same time 100° C. or lower, or 70° C. or lower, or even 60° C. or lower and at a relative humidity of 50% or higher, or 70% or higher, 80% or higher, even 85% or higher while at the same time 100% or lower, or 95% or lower, or even 90% or lower for five days. Photoluminescence measured on the same day can increase for the passivated composition more than 15 normalized units.

The peak luminescence emission intensity wavelength (nanometers), which is the point of highest luminescence for a composition when excited and a wavelength of about 365 nanometers (nm), is typically shifted, alternatively is shifted by at least 10, alternatively at least 20, alternatively from 10 to 150 nm, for passivated compositions comprising passivated silicon nanoparticles made by the method of the invention compared to a control sample that did not include a free radical reactive compound in the capture fluid composition in its method of making and measured on the same day. The difference in peak luminescence emission intensity wavelength can be observed the same day as produced and, preferably, after aging at 60° C. and 85% relative humidity for five days.

The passivated composition can be exposed to UV prior to aging the samples, where exposure to UV light modifies both the normalized photoluminescence intensity as well as the peak luminescence emission wavelength.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. % unless otherwise noted.

TABLE 1
List of abbreviations used in the examples.

| Abbreviation | Word |
|---|---|
| g | gram |
| Me | methyl |
| wt | weight |
| % | percent |
| mol | mole |
| cm | centimeter |
| ° C. | degrees Celsius |
| MHz | Megahertz |
| mL | milliliters |
| nm | nanometer |
| Diffoil Ultra 20 | (CAS number: 64741-88-4, refined petroleum |
| | oil distillates solvent-refined paraffinic) |
| au | Absorbance units |

Basic Plasma Nanoparticle Synthesis Procedure: The silicon nanoparticles were synthesized from a very high frequency low pressure plasma system. Ultra-high purity precursor gases (Ar, H₂, and SiH₄) were metered into a quartz tube via mass flow controllers at a specific ratio and pressure. Typical pressures of the quartz discharge tube were 133 Pascal to 667 Pascal (1-5 Torr). The gases were then dissociated via a very high frequency plasma discharge (100-150 MHz). The frequency was chosen to maximize the plasma coupling while minimizing the drive amplitude of the function generator that provides the sinusoidal signal to the Class A radio frequency amplifier.

The precursors gases were dissociated in the very high frequency plasma discharge via numerous reactions that follow Maxwell-Boltzmann statistics (due to the non-equilibrium nature of a plasma discharge). Silicon atoms coalesced, nucleated, and grew to form silicon nanocrystals in the plasma. The power of the plasma discharge controlled the temperature of the individual particles, allowing crystallinity control of the particles. Higher power yielded crystalline particles, while low power produced amorphous particles. The concentration of silicon atoms and the residence time of the atoms within the plasma controlled the size of the nanoparticles. Once the nanoparticles exited the plasma, via an orifice located at the bottom of the quartz plasma chamber, they no longer grew. The particles exited the plasma with SiHₓ (x<4), radicals (dangling bonds), and/or halogen species (if present in the discharge tube) on the surface. The particles were evacuated through the orifice by a large pressure drop into the deposition chamber. The pressure of the deposition chamber was less than 1.33 milliPascal (<1×10⁻⁵ Torr) (produced by a high vacuum pump, i.e., turbo-molecular, cryogenic, or diffusion pump). This large pressure drop created a supersonic jet of particles streaming out of the plasma chamber. The supersonic jet minimized any gas phase particle to particle interactions, thus keeping the particles monodispersed in the gas stream.

An agitated fluid (capture fluid), that is a low viscosity liquid (viscosity less than 0.2 Pascal seconds) at a pressure of less than 1.33 milliPascal (<1×10⁻⁵ Torr), was placed in a cup and is used to capture the particles at a low pressure. The location of the surface of the capture fluid was located within the distance of orifice in which the particles stay dispersed in the supersonic jet. The low viscosity of the capture fluid allowed the particles to be injected into the fluid without forming a film on the fluid's surface. Agitation of the fluid was used to refresh the surface of the capture fluid and force the captured particle away from the centerline of the orifice.

Once the silicon nanoparticle were captured in the capture fluid, the fluid and particle dispersion were removed from the vacuum chamber and the photoluminescence spectra measured. This measurement was performed on a Horiba FL3 spectrofluorometer with a 450 watt Xenon source. The excitation monochromator was set to 365 nm with a slit width of 2 nm. A 400 nm edge filter was placed in the beam path leading to the emission monochromator, downstream of the sample. The sample (silicon nanoparticles dispersed in the capture fluid), was placed in a 1 cm path length cuvette (either quartz or methylacrylate).

The emission spectra was measured at a right angle relative to the excitation beam (or at a 22.5° angle—front facing, if the sample is not transparent enough to allow a right angle measurement). The emission monochromator has a 2 nm slit width and the measurements were performed with an integration time of 0.1 s per wavelength and measured every 1 nm. The spectra is corrected for the quantum yield of the emission detector. The emission data is then fitted to a distribution (typically a Gaussian distribution for the silicon nanoparticles) with an adjusted R²>0.98. From this fit, the emission maximum wavelength, emission full width at half maximum (FWHM), and emission intensity were obtained. The emission spectra was then transformed to a diameter spectra via an equation that was fitted to the data produced by the silicon quantum dot model developed by Luo, Stradins, and Zunger,

$${d}_{p} = - 1.401 ln [ 0.195618 ( \frac{h c}{λ} - 1.2 \; 46 ) ]$$

where dₚ is the particle diameter, h is Planck's constant, c is the speed of light, and λ is the emission wavelength. This transformed spectra was then fitted to a Gaussian distribution and the mean particle diameter and diameter standard deviation were obtained.

The silicon nanoparticle and capture fluid dispersions were aged by placing them into a temperature-humidity oven (typically 60° C. and 85% relative humidity) for five to six days to passivate the surface of the particles with a diffusion limited oxide (SiOₓ, x<2). This passivation typically blue-shifts the emission spectra and increases the photoluminescent intensity via passivation of the exciton trap states, effectively turning more particles ON.

The absorbance of the silicon nanoparticle/capture fluid dispersion was measured via a Shimadzu UV 1800 uv-vis spectrophotometer. This is a double beam spectrophotometer with a measurement range of 190-1100 nm and a bandwidth of 1 nm. The neat capture fluid and the nanoparticle/capture fluid dispersion were placed into 1 cm path length matched quartz cuvettes. The absorbance spectra of the sample was then measured, subtracting out the spectra of the capture fluid (reference sample).

### Example 2 1-3; Comparative Example 1

Table 1 shows the silicon nanoparticles dispersion used in these examples. The capture fluid used for these experiments was Diffoil Ultra 20, a hydrocarbon vacuum pump oil from Kurt J. Lesker. The ligand that is used to functionalize the silicon nanoparticles in vacuum was allyl decanoate (C₁₃H₂₄O₂, CAS number: 57856-81-2). Allyl decanoate was dispersed into the Diffoil Ultra 20 fluid at 1 wt. % for samples B (Example 1) and C (Example 2) prior to loading into the system. Sample C (Example 2) had an additional three hour ultra-violet light exposure treatment after the silicon nanoparticle capture fluid dispersion was removed from the reactor, prior to the aging procedure. Samples A and D only have the Diffoil Ultra 20 as the capture fluid. Sample A is Comparative Example 1. Sample D (Example 3) had 1 wt. % (based on the Diffoil Ultra 20 mass) of allyl dodecanoate dispersed into the silicon nanoparticle/Diffoil Ultra 20 dispersion via ultrasonic agitation and then a three hour ultra-violet light exposure prior to the aging procedure. Table 2 provides run conditions used in this study. The gas precursor's values are the gas volume percentage. The frequency is the radio frequency of the plasma. P_{F} is the forward power, P_{R} is the reflected power, P_{C} is the power coupled, and P_{eff} is the power efficiency.

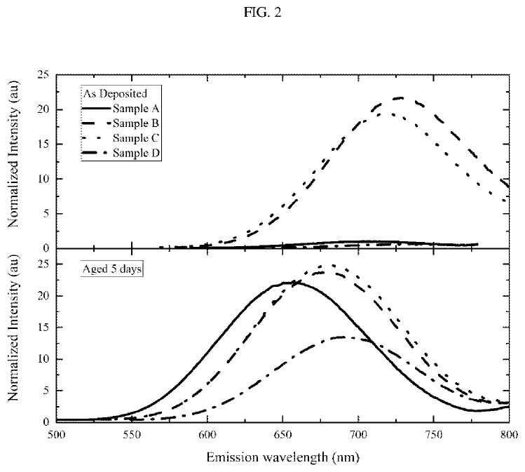

FIG. 2 displays the normalized photoluminescence emission spectra of the Examples and Comparative Example, where the different silicon nanoparticles were captured in Diffoil Ultra 20 hydrodcarbon fluid dispersions. The top plot in FIG. 2 is the as deposited spectra for the particle dispersions measured on the day they were synthesized, while the bottom plot is spectra for the particle dispersions after five days aging at temperature and humidity conditions (60° C. and 85% relative humidity). Sample A is the Comparative Example 1 and all spectrums are normalized to the maximum photoluminescent emission intensity of the as deposited Sample A (Comparative Example 1). 1 wt. % allyl dodecanoate was dispersed in the Diffoil Ultra 20 prior to silicon nanoparticle deposition for Samples B and C (Example 2), and after deposition for Sample D (Example 3). Samples C (Example 2) and D (Example 3) were then exposed to 3 hours of UV light prior to aging the samples at temperature and humidity.

TABLE 2

| | | | | | | | | | | Discharge | | |
|---|---|---|---|---|---|---|---|---|---|---|---|---|
| | | | | | | | | | | Tube | | |
| | Time | Ar | SiH₄ | H₂ | Freq. | | | | | Pressure | | |
| Sample | (min) | (%) | (%) | (%) | (MHz) | P_{F}(W) | P_{G}(W) | P_{C}(W) | P_{eff}(%) | (Pascal) | Capture Fluid | Post Deposition |
| A | 10 | 94.43 | 0.28 | 5.29 | 127 | 193 | 68 | 125 | 64.77 | 527 | Diffoil Ultra 20 | None |
| B | 10 | 94.43 | 0.28 | 5.29 | 127 | 190 | 67 | 123 | 64.74 | 527 | Diffoil Ultra 20 spiked | None |
| | | | | | | | | | | | with 1 wt % allyl | |
| | | | | | | | | | | | dodecanoate | |
| C | 10 | 94.43 | 0.28 | 5.29 | 127 | 192 | 68 | 124 | 64.58 | 525 | Diffoil Ultra 20 spiked | 3 hour UV |
| | | | | | | | | | | | with 1 wt % allyl | treatment |
| | | | | | | | | | | | dodecanoate | |
| D | 10 | 94.43 | 0.28 | 5.29 | 127 | 192 | 69 | 123 | 64.06 | 525 | Diffoil Ultra 20 | Post spike with 1 |
| | | | | | | | | | | | | wt % allyl |
| | | | | | | | | | | | | dodecanoate and 3 |
| | | | | | | | | | | | | hour UV treatment |

The silicon nanoparticle/hydrocarbon oil dispersions spiked with the allyl dodecanoate ligand prior to deposition of the nanoparticles in the low pressure plasma reactor, Samples B (Example 1) and C (Example 2), show a significantly higher initial photoluminescent emission intensity relative to the Comparative Example 1 (Sample A) which is silicon nanoparticles dispersed in the hydrocarbon oil only. Sample C (Example 2) underwent an additional three hours of ultra-violet light exposure after removal of the dispersion from the vacuum chamber in order to drive the hydrosilylation functionalization of the nanoparticles further. Sample D (Example 3) was a dispersion with the ligand molecule (allyl dodecanoate) dispersed into the solution after removal from the vacuum system and after three hours of ultra-violet light exposure. It is evident by the top plot in FIG. 2 that the in situ functionalization (i.e., the silicon nanoparticle being injected into the hydrocarbon capture fluid with functionalization ligand present at low pressure in the plasma reactor) provided significantly increased photoluminescent emission intensity of the silicon nanoparticles. Samples B (Example 1) and C (Example 2) have 21.7 and 19.3 fold peak intensities relative to the control sample as deposited, respectively. Sample D (Example 3), post deposition functionalization, had only a 0.65 fold photoluminescent emission intensity relative to the control sample (Sample A). There was a slight blue shift of the Sample A (Comparative Example 1) relative to the functionalized samples. Peak emission intensity wavelength on the day of deposition: Sample A (Comparative Example 1)=714 nm, Sample B (Example 1)=729 nm, Sample C (Example 2)=721 nm, and Sample D (Example 3)=736 nm.

The bottom plot of FIG. 2 shows the normalized photoluminescent emission spectra (normalized to the peak emission intensity of the as deposited Sample A) of the silicon nanoparticle dispersion used in this study after aging at 60° C. and 85% relative humidity for five days. In all cases, the samples increase in emission intensities over the as deposited samples, indicating the non-emissive trap states on the surface of the silicon nanoparticle are being passivated via the functionalization ligand and/or oxidation, thus turning more particles in the ensembles ON. The Comparative Example 1 (Sample A) had an increase of 22.1 fold in peak photoluminescent intensity. The in situ functionalized allyl dodecanoate samples (Samples B (Example 1) and C (Example 2)) peak emission intensity increased 23.8 and 24.9 fold, respectively, relative to the control sample's peak intensity on the day of deposition. These two samples only increased slightly during the aging process: Sample B (Example 1)—21.7× on Day 0 to 23.8× aged and Sample C (Example 2)—19.3× on Day 0 to 24.9× aged. This minor increase indicates that the particles were well passivated by the in situ functionalization of the allyl dodecanoate and only have small number of non-radiative surface trap states that were passivated via oxidation. The post processed functionalized sample, Sample D (Example 3), increased in emission intensity 13.5 fold relative to Comparative Example 1 (Sample A on day of deposition), illustrating that the traditional wet chemistry hydrosilylation worked. In all cases, the peak emission wavelength blue shifted due to the decrease in the silicon core of the nanoparticles from oxidation. The control sample had the largest blue shift in emission wavelength, λ=58 nm, while the in situ functionalized sample with post deposition uv treatment, Sample C (Example 2), had the smallest shift, λ=39 nm.

Visual observations of the samples were taken immediately after deposition under white light illumination. The samples that had allyl dodecanoate dispersed into the Dilloil Ultra 20 prior to silicon nanoparticle deposition, Examples 1 and 2 (Samples B and C, respectively), produce clear dispersions of the nanoparticles/hydrocarbon fluid. Samples without allyl dodecanoate, or with it mixed after the silicon nanoparticles were dispersed, Example 3 (Samples D) and Comparative Example 1 (Sample A), show cloudy suspensions. After 5 days of aging at 60° C. and 85% relative humidity the samples were excited by a 365 nm light from below. The samples where the functionalization ligand, allyl dodecanoate was mixed with the capture fluid prior to silicon nanoparticle deposition, Examples 1 and 2 (Samples B and C, respectively), show good dispersion of luminescent silicon particles. The samples that did not have the functionalization molecule loaded for in situ functionalization, Comparative Example 1 (Sample A) and Example 3 (Samples D), show that the silicon nanoparticles settle out of the fluid.

1. A method of passivating silicon nanoparticles, the method comprising:
synthesizing silicon nanoparticles having a diameter that is less than 10 nanometers by VHF radio frequency plasma discharge, wherein the silicon nanoparticles comprise a free radical, in a plasma reactor;
capturing the silicon nanoparticles in a capture fluid composition under vacuum, wherein the capture fluid composition comprises a capture fluid and a free radical-reactive compound, to form a captured silicon nanoparticle composition comprising the capture fluid, the silicon nanoparticles, and the radical reactive compound; and
reacting the radical-reactive compound with the free radical of the silicon nanoparticles to produce a passivated composition comprising a passivated silicon nanoparticle and the capture fluid.

2. A method according to claim 1, wherein the radical-reactive group of the radical-reactive compound is an unsaturated hydrocarbyl group.

3. A method according to claim 2, wherein the free radical-reactive compound is an unsaturated carboxylate having from 4 to 20 carbon atoms.

4. A method according to claim 3, wherein the free radical-reactive compound is prop-2-enyl decanoate.

5. A method according to claim 1, wherein the capture fluid is a hydrocarbon, a paraffinic hydrocarbon, a polysiloxane, or a fluorocarbon.

6. A method according to claim 1, wherein the hydrocarbon, polysiloxane, and fluorocarbon comprise an absorption modifying group.

7. A method according to claim 1, wherein the captured silicon nanoparticle composition is aged in passivating conditions.

8. A method as in claim 7, wherein the passivating conditions are a temperature from 45 to 80° C. and humidity from 50 to 95% relative humidity.

9. A method as in claim 1, wherein the silicon nanoparticle further comprises a non-radical reactive site, and wherein the radical-reactive compound reacts with the non-radical reactive site of the silicon nanoparticle.

10. A method according to claim 1, wherein the capture silicon nanoparticle composition is treated with ultraviolet light.
